(19) United States
(12) Patent Application Publication
(10) Pub. No.: US 2026/0157914 A1
(43) Pub. Date: Jun. 11, 2026

(54) SPINAL ALIGNMENT APPARATUS

(71) Applicant: Jesse Edward HENRY, Houston, TX (US)

(72) Inventor: Jesse Edward HENRY, Houston, TX (US)

(21) Appl. No.: 18/970,484

(22) Filed: Dec. 5, 2024

(51) Int. Cl. A61H 1/02

(52) U.S. Cl. CPC A61H 1/0296

(57) ABSTRACT

A spine alignment apparatus has a head band adapted to be affixed around the head of the user, a waist band adapted to be affixed around a waist of the user, and a spine strap having one end affixed to the head band and an opposite end affixed to the waist band so as to apply a tension between the head band and the waist band. The tension is suitable for resisting a forward movement of the head of the user with respect to the body of the user in order to maintain a proper cervical and thoracic alignment of the spine.

### CROSS-REFERENCE TO RELATED APPLICATIONS

Not applicable.

### FIELD OF THE INVENTION

The present invention relates to posture improving apparatus. More particularly, the present invention relates to apparatus for properly aligning a spine of a user. More particularly, the present invention relates to aligning the cervical spine adjacent to the head of the user with the thoracic spine of the user such that the head of the user is in proper vertical alignment with a body of the user.

### BACKGROUND OF THE INVENTION

Spine pain may include pain generated in the cervical, thoracic, lumbar or a combination of multiple sections of the spine. As an example, lower back pain is a problem for a large percentage of people. Most back pain is generated in the lumbar portion of the spine due to the axial force generated by the weight of the upper body that is transferred through the spine structure. A compromise or deformity in the structure of the spine may apply pressure to a nerve in or around the spine and therefore cause pain.

Neck pain is also a problem for a large percentage of people. By age 55, about 95% of the population will experience some degenerative condition of the cervical spine that may cause neck pain and/or upper extremity pain commonly accompanied with weakness. These non-tumorous and non-infectious conditions may include; degenerative intervertebral discs, disc herniations, internal disc disruption, vertebral osteophytes or spur formation and spondylolisthesis, and they may potentially result in loss of disc space, height, encroachment on spinal nerve roots where they exit the spinal cord, or radiculopathy, regional spinal cord compression, myelopathy, or vertebral joint instability. Moreover, yearly work-injury-related neck and/or back pain may frequently affect as much as 15 to 20% of the workforce.

Most people who have severe spinal pain tend to lie on their backs in order to temporarily relieve their pain. By lying on their back, a patient removes the axial pressure on the spine because the body weight is no longer transferred through the spine structure. Most pain generated in the spine is due to the axial forces produced by gravity and the weight of the body that is transferred through the spine structure. A compromise or deformity in the structure of the spine may apply pressure to nerves in or around the organ and therefore cause pain.

Spinal traction is the technique of removing the weight of a portion of the body from the spinal axis. Traction is often followed by stretching the spinal column in order to relieve stress within the spine. This method can temporarily remove a large amount of pain experienced by people with spinal disorders; however, there is a downside to current traction methods, for the majority of the currently available traction devices are very cumbersome and are difficult to use. Also, many must be used with direct interaction with a physician or other healthcare provider and, thus, deny the patient mobility when in traction. Because these problems often affect the everyday lives of those who suffer from sever neck pain, a portable traction device that can be used while the person goes about his daily tasks can prove to be a far better solution.

A method commonly used by chiropractic professionals for treatment of patients with neck pain involves restraining the patient in a retractor device and stretching their cervical spine along with a physical therapy regimen. It is common for this technique to relieve neck pain for a short period of time and is not effective as a long term palliative treatment of the pain.

While technology has resulted in our ability to produce instruments, devices and pharmaceuticals for treatment of spinal pain, there is still a clear need for an apparatus that would relieve the body weight on the spine while allowing the patient to have normal motion in the horizontal, sagittal and coronal body planes in a standing or sitting position. It is further desired for this apparatus to be low profile. Additionally, any intervention that would hasten the conservative recovery process, such as by facilitating independent patient participation in his/her own care, should also result in significant healthcare cost savings.

Heretofore, various posture improving apparatus have been recognized in the prior art. However, these apparatus tend to be wrapped around the shoulders and back of the user so as to assure that the lower spine is in a proper alignment. Apparatus have not been developed today wherein a user can assure proper alignment between the cervical spine and the thoracic spine.

In the past, various patents have issues relating to such spinal alignment apparatus. For example, U.S. Pat. No. 6,050,965, issued on Apr. 18, 2002, B. H. Pillai shows a cervical collar for lifting the skull of a wearer. This collar includes a core, a pair of bladders, and an inflating apparatus. The core replaceably encircles the neck of the wearer. The pair of bladders are inflatable and disposed on the core. The inflating apparatus is in fluid communication with the pair of bladders. When the pair of bladders are inflated to a predetermined pressure by the inflating apparatus, the skull of the wearer is gently pushed off the shoulders of the wearer. This relieves downward pressure on the cervical spine of the wearer by forming an intrinsic net traction.

U.S. Pat. No. 6,213,968, issued on Apr. 10, 2001 to Heinz, et al., teaches a custom fitted orthotic device. This orthotic device includes an orthosis body adapted to be around the torso of a wearer. The orthosis body has at least two segments in juxtaposed relationship. Means are provided at free end portions of the segments to releasably secure the end portions to one another. At least two cables are provided in which each cable operatively connects to the segments. At least two sets of pulleys are mounted on the segments with each cable operatively connected to the segments running through a pulley on each side of the segments in alteration.

U.S. Pat. No. 8,066,654, issued on Nov. 29, 2011 to Sandifer et al., provides a spinal orthosis and method of applying extension and compression forces onto a user spine. The spinal orthosis includes a lumbo-sacral compression unit conforming to a portion of a user's torso and exerting an encircling compressive force to provide a hydraulic lift. A posterior spinal frame member is secured by the limbo-sacral compression unit to be cantilevered upward along the user's spine. A pair of adjustable shoulder strap assemblies are connected to an upper portion of the posterior spinal frame member and adjacent a lower portion of the posterior spinal frame member to enable a user to adjustably apply a thoracic force with adjustable and controlled buckles and straps positioned on the user's chest.

U.S. Pat. No. 8,864,695, issued on Oct. 21, 2014 to T. M. Thorton, shows an adjustable brace apparatus that has a pair of elongate wings configured for wrapping around and substantially conforming to a portion of a body of the user. An adjustment sleeve is configured for slidably receiving each of the wings. A pair of first and second tightening segments are removably engageable with each of the wings and slidably engaged and suspended within the adjustment sleeve. This enables the wings to substantially float and selectively overlap atop one another within the adjustment sleeve.

U.S. Pat. No. 9,358,415, issued on Jun. 7, 2016 to A. O. Champion, teaches a spinal therapy device that can be used by an individual to apply over pressure, spinal decompression, spinal joint mobilization, or a combination thereof, to the spine. A plurality of belts are provided, along with handles, so as to allow the adjustment between each of the components to be achieved.

U.S. Pat. No. 10,898,750, issued on Jan. 26, 2021 to Angulo provides a body alignment and correction device that includes a belt for wearing around a waist of the user. The device further includes removable and repositionable foam blocks to displace portions of the belt away from the user's body. The stimulation of the abdominal or back muscles of the user is achieved by selectively placing foam blocks to space a portion of the belt away from the user's body.

U.S. Pat. No. 11,213,720, issued on Jan. 4, 2022 to D. Fano, discloses a posture training device that includes a belt with a body contacting portion extending between a first edge and a second edge. It also includes an adjustable and releasable securing mechanism adapted to secure the posture training device around a midsection of a wearer. The posture training device also includes a vertebrae contact portion having a concave surface extending between a first end and a second end. The concave surface can have a predetermined depth such that the concave surface is configured to contact and support at least one vertebrae.

U.S. Patent Application Publication No. 2011/0184325, published on Jun. 28, 2011 to Behzadian et al., teaches an orthopedic apparatus for mobilizing, stretching and protecting the spinal column. The device is a wearable frame equipped with a series of leaf or coil springs where the spring forces are adjusted so that the forces are applied parallel to the spine and are equal to or greater than the individual's body weight above the device. The compressed spring supplies enough opposing force to transfer the downward force resulting from the weight of the body above the device to the anatomy below the device while allowing normal spine motion relative to the body.

U.S. Patent Application Publication No. 2022/0039991, published on Feb. 10, 2022 to Heronen et al., shows a thoracic, lumbar sacral orthosis attachment for configuring an orthopedic device as a thoracic, lumbar sacral orthosis by connecting the attachment to the orthopedic device. The attachment has an anterior aspect including an anterior panel arranged to connect to an orthopedic device. An anterior thoracic extension is securable to the anterior panel. A support bar extends from the anterior thoracic extension. A strap system includes an auxiliary strap system and/or a shoulder strap system removably secured to a surface of the orthopedic device or the anterior's thoracic extension.

International Publication No. WO 2017/123466, published on Jul. 20, 2017 to R. C. Murdock, discloses an external spinal brace system. This system includes a plurality of support mechanisms. A first support mechanism is coupled, during use, to a second support mechanism such that the first and second support mechanisms are inhibited from decoupling. A coupling system is provided that couples the plurality of support mechanisms to a subject such that the plurality of support mechanisms are positioned, during use, along at least a portion of the subject's spine.

It is an object of the present invention to provide a spinal alignment apparatus that helps to maintain the head of the user in a neutral posture and to align the cervical spine with a thoracic spine.

It is another object of the present invention to provide a spinal alignment apparatus that urges the head toward the head neutral position.

It is another object of the present invention to provide a spinal alignment apparatus that is easy to apply.

It is another object of the present invention to provide a spinal alignment apparatus that is easy to store.

It is another object of the present invention provide a spinal alignment apparatus that is comfortable.

It is another object of the present invention to provide a spinal alignment apparatus that is lightweight.

It is a further object of the present invention to provide a spinal alignment apparatus that allows the user to move angularly against the resistance of the apparatus.

It is another object of the present invention to provide a spinal alignment apparatus that is washable.

It is still another object of the present invention to provide a spinal alignment apparatus that is wearable for an extended period of time.

It is still a further object of the present invention to provide a spinal alignment apparatus that can be worn inside or outside the clothing of the user.

It is still another object of the present invention to provide a spinal alignment apparatus that provides feedback to the user of when his or her head is in proper alignment with the rest of the spine of the user.

These and other objects and advantages of the present invention will become apparent from a reading of the attached specification and appended claims.

### SUMMARY OF THE INVENTION

The present invention is a spinal alignment apparatus that comprises a head band adapted to be affixed around the head of the user, a waist band adapted to be affixed around the waist of the user, and a spine strap having one end affixed to the head band and opposite end affixed to the waist band so as to apply a tension between the head band and the waist band.

The headband has an adjustable diameter. In one embodiment of the present invention, the headband is formed of a web of polymeric material. The web of polymeric material has a first section of hook-and-loop material adjacent one end thereof and a second section of hook-and-loop material adjacent an opposite end thereof. The first section of hook-and-loop material engages the second section of complementary hook-and-loop material so as to adapt to a size of the head of the user. In an alternative embodiment, the headband has an elastic portion therein so as to allow the headband to have the adjustable diameter.

The waist band has at least a portion formed of an elastic material. The waist band has a hook-and-loop material section affixed or formed at the rearward surface of the waist band. The spine strap has a complementary hook-and-loop material section engageable with the hook-and-loop material section of the waist band. The hook-and-loop material section of the waist band has a raised section of the hook-and-loop material extending outwardly of a broad section of the hook-and-loop material. The raised section is positioned generally centrally of the broad section.

The waist band has a hook-and-loop material section at one end thereof and a complementary hook-and-loop material section at an opposite end thereof such that the hook-and-loop material sections engage with each other when the waist band extends around the waist of the user. The waist band has a section of hook-and-loop material affixed thereto between the ends of the waist band. The section of hook-and-loop material is engageable with the complementary hook-and-loop material section when the waist band is rolled up upon itself. The waist band also has a finger receptacle formed or affixed to a surface thereof. The finger receptacle is adapted to receive a finger of the user therein so as to allow the user to tighten the waist band around the waist of the user.

The spine strap is has at least a portion formed an elastic material. The spine strap has a hook-and-loop material section adjacent an end thereof, and a complementary hook-and-loop material section in spaced relation to the hook-and-loop material section. The hook-and-loop material section engages the complementary hook-and-loop material section when the end of the spine strap is wrapped around the head band. The spine strap has a hook-and-loop material section formed of a lower portion thereof. The hook-and-loop material section of the spine strap is engageable with a complementary hook-and-loop material section on the waist band.

The present invention is also a method of aligning a spine of a user such that the cervical spine is aligned with the thoracic spine. This method includes the steps of: (1) wrapping or extending a head band around a head of the user; (2) wrapping a waist band around a waist of the user; (3) affixing one end of a spine strap to or around a rearward surface of the wrapped or extended head band; and (4) affixing an opposite end of the spine strap to or around a rearward surface of the wrapped waist band such that the spine strap is in tension between the head band and the waist band.

In the method of the present invention, the spine strap has a first section of hook-and-loop material adjacent one end of the spine strap and a second section of complementary hook-and-loop material in spaced relation to the first section. The step of affixing one end of the spine strap comprises wrapping one end of the spine strap around the rearward surface of the headband and engaging the first section of hook-and-loop material to the second section of hook-and-loop material such that the spine strap is affixed to the head band.

The method of the present invention further includes affixing a hook-and-loop material section to the rearward surface of the waist band. The step of affixing the opposite end of the spine strap includes affixing a complementary hook-and-loop material section to a lower end of the spine strap, and engaging the affixed complementary hook-and-loop material section of the spine strap with the fixed hook-and-loop material section of the waist band.

The step of wrapping the head band includes applying a section of hook-and-loop material to one end of the head band, applying a complementary section of hook-and-loop material to an opposite end of the head band, and engaging the applied section of hook-and-loop material with the applied complementary section of hook-and-loop material so as to encircle a forehead of the user.

The step of affixing the one end of the spine strap to the rearward surface of the head band can include affixing a hook-and-loop material adjacent one end of the spine strap, fixing a complementary hook-and-loop material to the spine strap in spaced relation to the affixed hook-and-loop material, and wrapping the one end of the spine strap around the rearward surface of the head band such that the hook-and-loop material engages the complementary hook-and-loop material of the spine strap.

In the method of the present invention, the tension between the head band of the waist band resists a forward movement of the head of the user. Each of the head band, the waist band and the spine strap includes at least a portion of an elastic material. The head bond can also have a sweat-absorbent thereon.

The spinal alignment apparatus of the present invention addresses the entire spine and primarily the head and neck alignment of the cervical spine. This addresses the main portion of the spine. The prior art posture correction devices do not work above the shoulders. When the cervical spine is correctly aligned, the thoracic spine and the lumbar spine will fall in line. In other words, the human body is perfectly interconnected such that, when one link is moved, it will move an adjacent or another link in the human body system.

The spinal alignment apparatus of the present invention automatically assists in keeping the cervical spine perfectly aligned while sitting, standing, swimming, walking, working, yoga, meditating, golfing, gymnastics, and exercising. It is also useful for those that lift weights. The present invention is very lightweight. It works effectively whether the user is sweating or in water. They cervical spine apparatus of the present invention is easy to carry in luggage. Since there are no metal parts to the present invention, it will not be flagged by TSA when traveling on an airplane. The present invention is a unisex product. It can be applied and removed easily and quickly. It is simple to operate and to adjust for height, weight, and the desired tension.

The spinal alignment apparatus of the present invention will remind the user to stay straight. In order to help correct and prevent poor spinal posture when the head and upper trunk are in the forward-flexed position. The present invention helps to prevent slouchiness by achieving and sustaining the neutral posture.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a frontal view of a human body with the spinal alignment apparatus applied thereto.

FIG. 2 is a rearward view of the human body with the spinal alignment apparatus applied thereto.

FIG. 3 is a side view of the human body with the spinal alignment apparatus applied thereto.

FIG. 4A is a view of one side of the head band of the spinal alignment apparatus of the present invention.

FIG. 4B is an opposite side view of the head band of the spinal alignment apparatus of the present invention.

FIG. 5A is a side elevational view of the waist band of the spinal alignment apparatus of the present invention.

FIG. 5B is an opposite is an elevated opposite side view of the waist band of the spinal alignment apparatus of the present invention.

FIG. 6A is an elevated side view of one side of the spine strap of the spinal alignment apparatus of the present invention.

FIG. 6B is an elevated opposite side view the spine strap of the spinal alignment apparatus of the present invention.

### DETAILED DESCRIPTION OF THE INVENTION

Referring to FIG. 1, there is shown a human body 10 having the spinal alignment apparatus 20 applied thereto. Specifically, in FIG. 1, it can be seen that there is a head band 30 that extends around the forehead 32 of the human body 10. FIG. 1 further shows that there is a waist band 40 that extends around the waist 42 of the human body 10. The waist band 40 can be suitably wrapped around the waist so as to join at end 44. As such, the waist band 40 achieves a secure fit to the waist 42 of the human body 10. The head band 30 can be formed so as to have at least a portion of an elastic material and also to have a sweat-receiving portion. As such, this can elastically engage with the forehead 32 of the human body 10 in order to provide an easy and comfortable fit therewith.

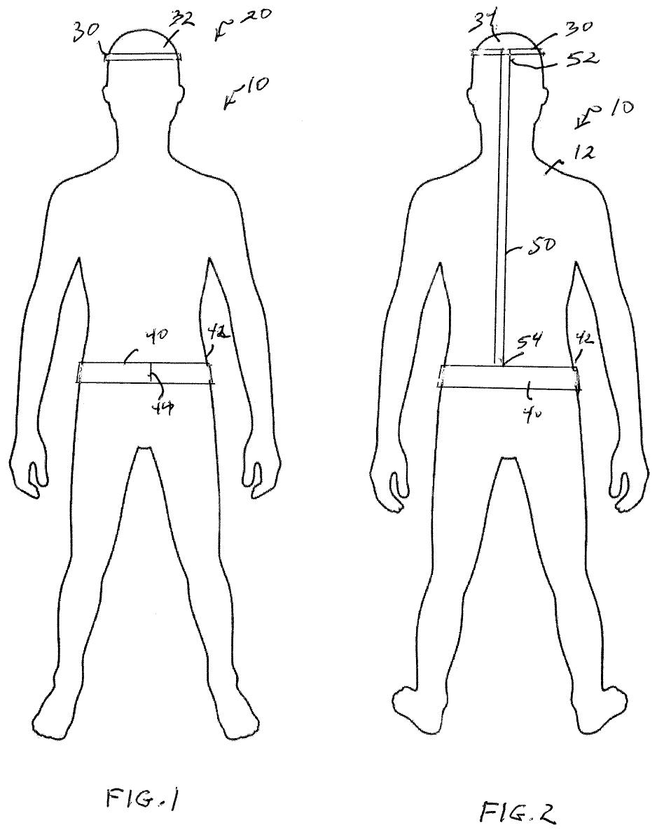

FIG. 2 shows the back 12 of the human body 10. The head band 30 is shown as extending around the back of the skull 34 of the human body 10. A spine strap 50 has an upper end 52 affixed to the head band 30. A lower end 54 of the spine strap 50 is secured to the waist band. 40. Waist band 40 is illustrated as extending around the waist 42 of the human body 10. The spine strap 50 is configured so as to maintain a tension between the head band 30 and the waist band 40.

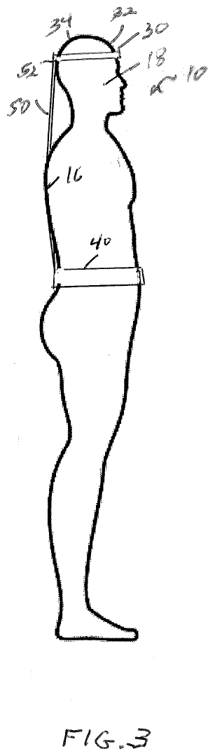

FIG. 3 is a side view of the human body 10. Once again, can be seen that the head band 30 extends around the forehead 32 and skull. 34 of the human body 10. The spine strap 50 has its upper end 52 either secured to the rearward surface of the head band 30 or wrapped around the rearward surface of the head band 30 so as to be securely affixed thereto. Spine strap 30 extends directly downwardly from the head band 30 and across the back 16 of the human body 10 so as to have a lower end engaged with the waist band 40. This configuration assures that the head 18 of the human body 10 is properly aligned with the spine of the user 10. The elastic spine strap 30 applies a tension between the head band 30 and the waist band 40 so as to be resistive up any forward movement of the head 18 with respect to the back 16 or the spine of the user. This arrangement further provides feedback in the event that the user moves his or her head 18 forwardly or from side to side. As such, this is a constant reminder to keep the head in a proper position during all forms of human activity.

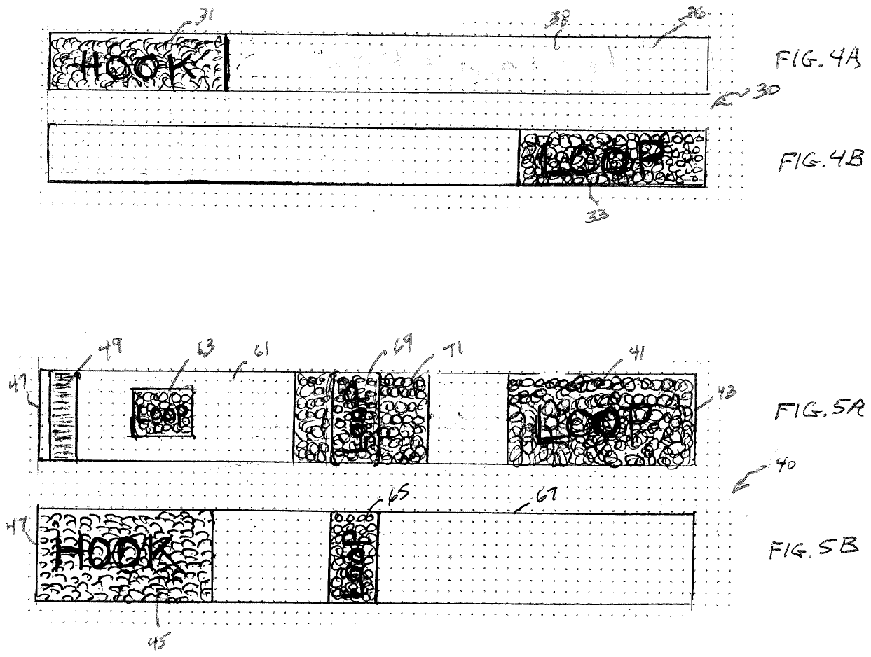

FIGS. 4A and 4B show the head band 30. Head band 30 is in the form of strap 36 having at least a portion 38 formed of an elastic material. It should be noted that the head band 30 has a section of hook-and-loop material 31 at one end and a section of hook-and-loop material 33 at an opposite end thereof. The section of hook-and-loop material 31 and the complementary section of hook-and-loop material 33 can be applied to the inner or outer surfaces of the strap 38. In this configuration, the head band 30 can be wrapped around the head of the user. Once the head band 30 is wrapped or extended around the head of the user, the user can engage a look-and-loop material section 31 with the hook-and-loop material section 33 so as to fix the head band onto the head 18 of the user 10. Alternatively, the head band 30 can be a continuous loop that is configured to firmly engage the head of the user in the nature of conventional head bands. The engagement between the head band 30 and the head 18 of the human body 10 should be sufficiently strong so as to resist any deflection upon the attachment of the spine strap 50 to the rearward surface of the head band 30. The head band 30 can be in the nature of a sweatband or having a sweat receiving material affixed thereto.

FIGS. 5A and 5B show the waist band. 40. It can be seen that the waist band 40 has a section of section 41 of hook-and-loop material adjacent and end 43 thereof. The waist band 40 also includes a section 45 of complementary hook-and-loop material adjacent an opposite end 47. As such, when the waist band 40 is wrapped around the waist 42, the hook-and-loop material section 41 of hook-and-loop material will engage with the section 45 of hook-and-loop material. This engagement will create a strong fit against the waist 42 of the user.

In order to facilitate the ability to strongly affix the waist band 50 over the waist 42 of the human body 10, a finger receptacle 49 is affixed adjacent to the end 47. It could also be affixed adjacent to the end 43, if desired. The finger receptacle 49, in the preferred embodiment of the present invention, is a webbing of non-elastic material. This finger receptacle 49 will generally be applied to the inner surface 61 of the waist band 40. As such, a user can insert his or her fingers into the finger receptacle 49 so as to strongly pull the ends 43 and 47 together until the section 41 of hook-and-loop material can be engaged with the section 45 of complementary hook-and-loop material.

It should be noted that there is a small square 63 of hook-and-loop material that is also affixed to the inner surface 61 of the waist band 40. The square 63 is positioned inwardly from the end 47 and inwardly from the finger receptacle 49. This square 63 can be used so as to facilitate the stowage of the spinal alignment apparatus 20 when not in use. In other words, the waist belt 40 can be wrapped around itself until the square 63 of the hook-and-loop material will engage with the complementary section 45 of complementary hook-and-loop material. As such, the waist band can be conveniently rolled upon itself so as to create a compact configuration for transportation and storage.

FIG. 5B further shows that there is a hook-and-loop material section 65 formed generally centrally of the length of the strap 67 of the waist band 40. This section 65 of hook-and-loop material is configured so as to receive the lower end of the spine strap under those circumstances in which the spine strap is wrapped under and around the waist band 40. Similarly, there is a raised section 69 of hook-and-loop material formed on the inner surface 61 of the waist band 40. This raised section 69 is also intended to be affixed to a lower end of the spine strap 50 when the lower end is engaged with the waist band 40. There is a broad section 71 of hook-and-loop material that extends outwardly of the section 69. The broad section 71 has a larger area than the area of a section 69. In other words, when the lower end of the spine strap 50 is moved downwardly so as to engage with the waist band 40, the section 71 can engage with complementary hook-and-loop material at the lower end of the spine strap in the event that the spine strap is misaligned with a raised section 69. This is particularly helpful since the connection between the spine strap 50 and the waist band 40 is carried out at the back of the user. As such, the user will not have a clear view of exactly where to place the lower end of the spine strap. The section 65 will engage with the lower end of the spine strap when the spine strap is wrapped over and around the waist band. This achieves a double secure connection between the bottom of the spine strap and the waist band 40.

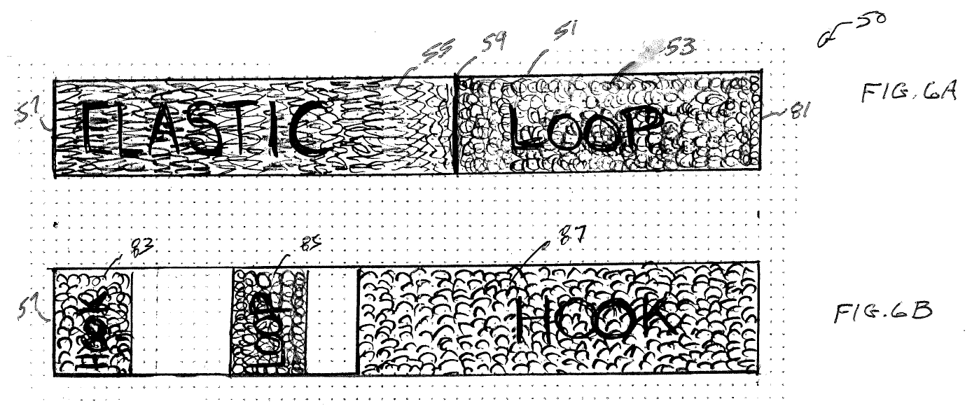

FIGS. 6A and 6B show the spine strap 50. FIG. 6A shows one side while FIG. 6B shows an opposite side. In particular, it can be seen that the spine strap 50 has a webbing 51, upon which the complementary section of hook-and-loop material 53 is affixed. There is an elastic section 55 that is formed on the spine strap 55. As shown in FIG. 6A, the elastic section 55 extends from end 57 toward the center 59. The complementary section 53 of hook-and-loop material can extend from the elastic section 55 toward the opposite end 81.

The opposite side of the spine strap 50 is illustrated in FIG. 6B. As can be seen, the end 57 has a section of hook-and-loop material 83 affixed thereto and a complementary section 85 of hook-and-loop material affixed thereto in spaced relation to the section 83. As such, when the end 57 of the spine strap 50 is wrapped around the rearward surface of the head band 30, the section 83 of hook-and-loop material can loop around and engage with a complementary section of hook-and-loop material 85. The remaining portion of the spine strap 50 includes a portion of complementary hook-and-loop material 87. This complementary section 87 of hook-and-loop material will engage with a hook-and-loop material sections 65 and 69 of the waist band 40. As such, this arrangement assures a secure connection between the spine strap 50, the head band 30 and the waist band 40.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

1. A spinal alignment apparatus comprising:
a head band adapted to be affixed around a head of the user;
a waist band adapted to be affixed around a waist of the user; and
a spine strap having one end affixed to said head band and an opposite end affixed to said waist band so as to apply a tension between said head band and said waist band.

2. The spine alignment apparatus of claim 1, the one end of said spine strap being affixed to a rearward surface of said head band, the opposite end of said spine strap being affixed to a rearward surface of said waist band.

3. The spinal alignment apparatus of claim 2, said head band having at least a portion formed of an elastic material.

4. The spine alignment apparatus of claim 3, said head band having a hook-and-loop material section affixed to the rearward surface of said head band, said spine strap having a complementary hook-and-loop material section engageable with the hook-and-loop material section of said head band.

5. The spinal alignment apparatus of claim 2, said waist band having at least a portion formed of an elastic material.

6. The spine alignment apparatus of claim 5, said waist band having a hook-and-loop material section affixed or formed at the rearward surface of said waist band, said spine strap having a complementary hook-and-loop material section engageable with the hook-and-loop material section of said waist band.

7. The spinal alignment apparatus of claim 6, wherein the hook-and-loop material section of said waist band has a raised portion of the hook-and-loop material extending outwardly of a broad section of the hook-and-loop material, the raised section positioned generally centrally of the broad section.

8. The spinal alignment apparatus of claim 1, said waist band having a hook-and-loop material section at one end thereof and a complementary hook-and-loop material section at an opposite end thereof such that the hook-and-loop material sections engage with each other when the waist band extends around the waist of the user.

9. The spinal alignment apparatus of claim 8, said waist band having a section of hook-and-loop material affixed between the ends of said waist band, the section of hook-and-loop material being engageable with the complementary hook-and-loop material section when said waist band is rolled up on itself.

10. The spinal alignment apparatus of claim 1, said waist band having a finger receptacle formed or affixed to a surface thereof, the finger receptacle adapted to receive a finger of the user therein so as to allow the user to tighten the waist band.

11. The spine alignment apparatus of claim 1, said spine strap having at least a portion formed of an elastic material.

12. The spinal alignment apparatus of claim 11, said spine strap having a hook-and-loop material section adjacent and end thereof, and a complementary hook-and-loop material section in spaced relation to the hook-and-loop material section, the hook-and-loop material section engaging the complementary hook-and-loop material section when the end of said spine strap is wrapped around the head band.

13. The spinal alignment apparatus of claim 11, said spine strap having a hook-and-loop material section formed at a lower portion thereof, the hook-and-loop material section of said spine strap being engageable with a complementary hook-and-loop material section on said waist band.

14. A method of aligning a spine of a user such that the cervical spine is in alignment with the thoracic spine, the method comprising:
wrapping or extending a head band around a head of the user;
wrapping a waist band around a waist of the user;
affixing one end of a spine strap to a rearward surface of the wrapped or extended head band; and
affixing an opposite end of the spine strap to a rearward surface of the wrapped waist band such that the spine strap is in tension between the head band and the waist band.

15. The method of claim 14, further comprising:
applying a hook-and-loop material to the rearward surface of the head band, the step of affixing the one end of the spine strap comprising:
affixing a complementary hook-and-loop material to an upper end of the spine strap; and
engaging the affixed complementary hook-and-loop material of the spine strap to the hook-and-loop material of the head band.

16. The method of claim 14, further comprising:
affixing a hook-and-loop material section to the rearward surface of the waist band, the step of affixing the opposite end of the spine strap comprising:
affixing a complementary hook-and-loop material section to a lower end of the spine strap; and
engaging the affixed complementary hook-and-loop material section of the spine strap with the affixed hook-and-loop material of the waist band.

17. The method of claim 14, wherein the step of wrapping the head band comprises:
applying a section of hook-and-loop material to one end of the head band;
applying a complementary section of hook-and-loop material to an opposite end of the head band; and
engaging the applied section of hook-and-loop material with the applied complementary section of hook-and-loop material so as to encircle a forehead of the user.

18. The method of claim 14, wherein the step of affixing the one end of the spine strap to the rearward surface of the head band comprises:
affixing a hook-and-loop material adjacent one end of the spine strap;
affixing a complementary hook-and-loop material to the spine strap in spaced relation to the affixed hook-and-loop material; and
wrapping the one end of the spine strap around the rearward surface of the head band such that the hook-and-loop material engages the complementary hook-and-loop material of the spine strap.

19. The method of claim 14, wherein the tension between the head band and the waist band resists a forward movement of the head of the user.

20. The method of claim 14, wherein each of the head band and the waist band and the spine strap has at least a portion formed of an elastic material.
